(19) United States
(12) Patent Application Publication
(10) Pub. No.: US 2015/0007798 A1
(43) Pub. Date: Jan. 8, 2015

(54) CONTROL METHOD OF FUEL PUMP FOR VEHICLE AND ELECTRONIC CONTROLLER

(71) Applicant: Hyundai Motor Company, Seoul (KR)

(72) Inventors: Cheol Hun Cho, Suwon (KR); Ju Tae Song, Hwaseong (KR)

(73) Assignee: HYUNDAI MOTOR COMPANY, Seoul (KR)

(21) Appl. No.: 14/070,931

(22) Filed: Nov. 4, 2013

(30) Foreign Application Priority Data
Jul. 5, 2013 (KR) 10-2013-0078869

(51) Int. Cl. F02M 69/02

(52) U.S. Cl. CPC F02M 69/02
USPC 123/495

(57) ABSTRACT

A control method and system of a fuel pump for a vehicle are provided and include determining, by a controller, whether an accelerator pedal signal is rapidly increased and comparing, by a controller, a current control quantity of the fuel pump with a predetermined reference control quantity in response to determining that the accelerator pedal signal is rapidly increased. In addition, the controller is configured to set the control quantity of the fuel pump as a predetermined jump control quantity when the current control quantity is less than the predetermined reference control quantity.

### CROSS-REFERENCE TO RELATED APPLICATION

This application claims under 35 U.S.C. §119(a) priority to Korean Patent

Application No. 10-2013-0078869 filed on Jul. 5, 2013, the entire contents of which are incorporated herein by reference.

### BACKGROUND

(a) Technical Field

The present disclosure relates to control method of a fuel pump for a vehicle, and more specifically to a technology that controls a low pressure pump of an engine having a fuel supplying device provided with the low pressure pump and a high pressure pump.

(b) Background Art

Recently, a fuel supplying device has been used in a vehicle engine, in which a low pressure pump and a high pressure pump are connected in series, and a fuel pumped through the lower pressure pump is pumped again to a high pressure by the high pressure pump and supplied to an injector. In addition, the low pressure pump is driven to improve fuel efficiency of a vehicle to vary the pressure and flux of fuel to be pumped, reflecting driving conditions of a vehicle wherein as shown in FIG. 1, a controller executes PWM (Pulse Width Modulation) duty ratio of the low pressure pump to be increased and decreased or maintained by comparing a target pressure which is set based on driving conditions of a vehicle with a measured pressure.

As described above, when an accelerator is frequently engaged for a short period of time in a vehicle in which the PWM duty ratio of the low pressure pump is controlled based on the drive conditions thereof, as shown FIG. 2, a fuel consumption section of an engine decreases, and thus the actual measurement pressure of the pump becomes greater than the target pressure thereof.

In particular, when the accelerator is engaged again with a WOT (Wide Open Throttle), a target pressure is increased due to fuel consumption of an engine, but the PWM duty ratio increases rapidly again under the condition where the PWM duty ratio decreases due to the high actual measurement pressure. However, in a section where the PWM duty decreases, a fuel discharging quantity of the pump decreases compared to a fuel consumption quantity of engine, at this time fuel of a fuel line is consumed instantaneously, and thus the actual measurement pressure is decreased to about 2.3 bar. In other words, as shown in A section of FIG. 2, when the accelerator pedal is engaged abruptly, the duty ratio is decreased since the actual measurement pressure has increased while the target pressure is increasing, thereby delaying the fuel response.

As described above, when a FUEL CUT operation is performed when a vehicle in which the PWM duty of the low pressure pump is controlled based on driving conditions of a vehicle travels on the expressway, etc., injection of an injector is stopped, causing the fuel measurement pressure of the low pressure pump to increase even while decreasing the PWM duty and the fuel measurement pressure becomes greater than the fuel target pressure. Accordingly, PWM duty may be set as a minimum value.

Under the conditions as described above, when a driver re-accelerates a vehicle by operating (e.g., engaging) an accelerator pedal, the PWM duty increases again only when the measurement pressure of the low pressure pump becomes less than the target pressure thereof. However, this procedure costs time, and thus the fuel pressure of the low pressure pump increases to a proper level only when a certain time is delayed from a point when a FUEL CUT is actually released by an operation of the accelerator by a driver, thereby decreasing acceleration response and drivability of a vehicle.

The description provided above as a related art of the present invention is just for helping understanding the background of the present invention and should not be construed as being included in the related art known by those skilled in the art.

### SUMMARY

The present invention provides a control method of a fuel pump for a vehicle, in which even when an accelerator is operated repeatedly in a vehicle provided with a fuel supplying device in which a low pressure pump controlled variably and a high pressure pump are connected in series, a fuel pressure of the low pressure pump may be increased to improve an acceleration response and drivability of a vehicle.

In particular, a control method of a fuel pump for a vehicle according to an exemplary embodiment of the present invention may include: determining whether an accelerator pedal signal is rapidly increased; comparing a current control quantity of the fuel pump with a predetermined reference control quantity in response to determining that the accelerator pedal signal is rapidly increased; and control quantity replacing in which the control quantity of the fuel pump is to be set as a predetermined jump control quantity when the current control quantity is less than the predetermined reference control quantity as a result of performing the control quantity comparing step.

The jump control quantity in the control quantity replacing may be the same value as the reference control quantity in the control quantity comparing. Further, the control method of a fuel pump for a vehicle of claim may further include monitoring an accelerator pedal signal before the accelerator pedal signal determination. In the accelerator pedal signal determination, a rapid increase of the accelerator pedal signal may be determined when the accelerator pedal signal varies from a lowest limit point or less to an upper limit point or greater within a predetermined time. In the control quantity replacing, the control quantity of the fuel pump may be replaced with a predetermined jump control quantity for a predetermined time. The control quantity may be a PWM duty ratio which controls the fuel pump. Additionally, an electronic controller may be configured to perform the control method of a fuel pump for a vehicle according to an exemplary embodiment of the present invention.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is an exemplary view showing a fuel pump control method for a vehicle according to a related art;

FIG. 2 is exemplary graphs showing control results obtained from a control method of a fuel pump for a vehicle according to a related art;

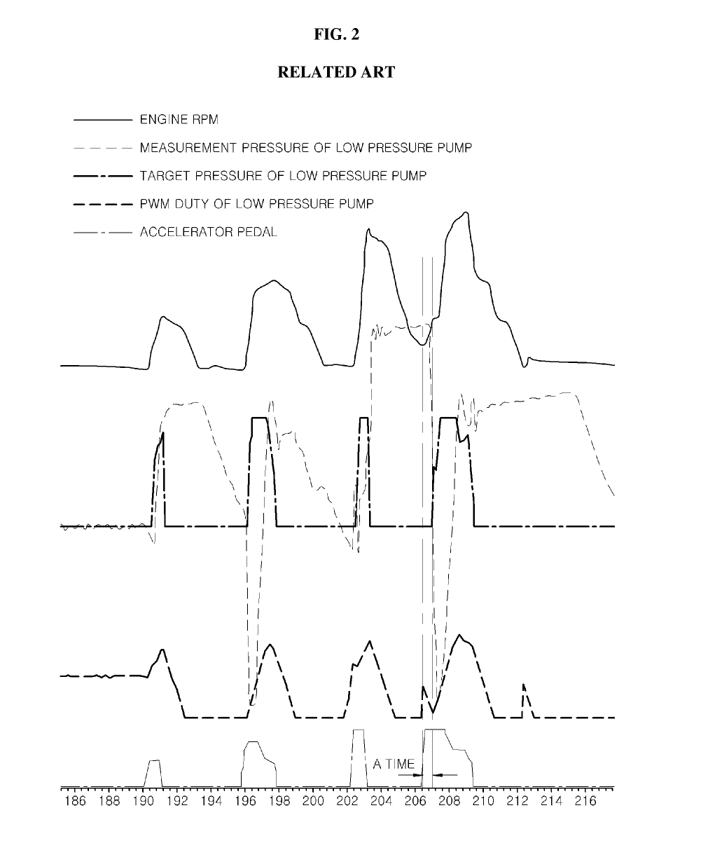

FIG. 3 is an exemplary flowchart showing a control method of a fuel pump for a vehicle according to an exemplary embodiment of the present invention; and

FIG. 4 is exemplary graphs showing control results obtained from a control method of a fuel pump for a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, a control method of a fuel pump for a vehicle according to an exemplary embodiment of the present invention will be described, referring to the accompanying drawings.

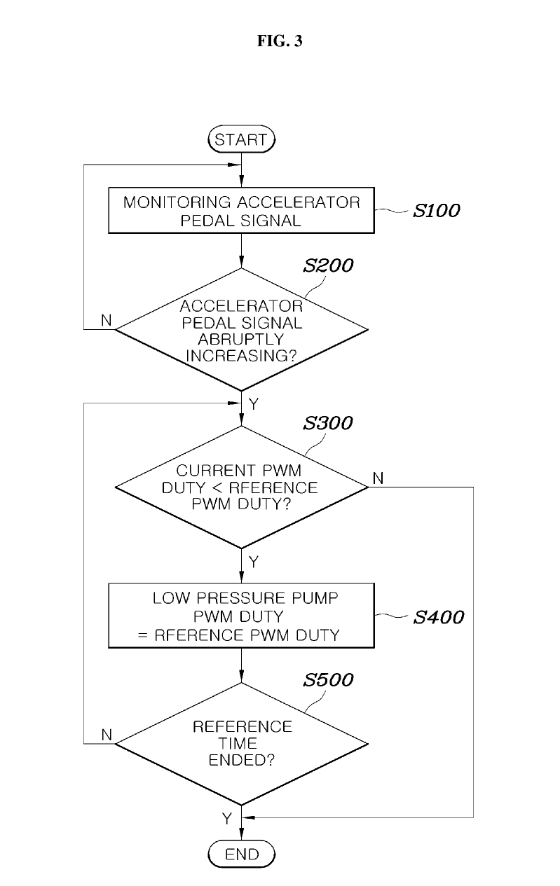

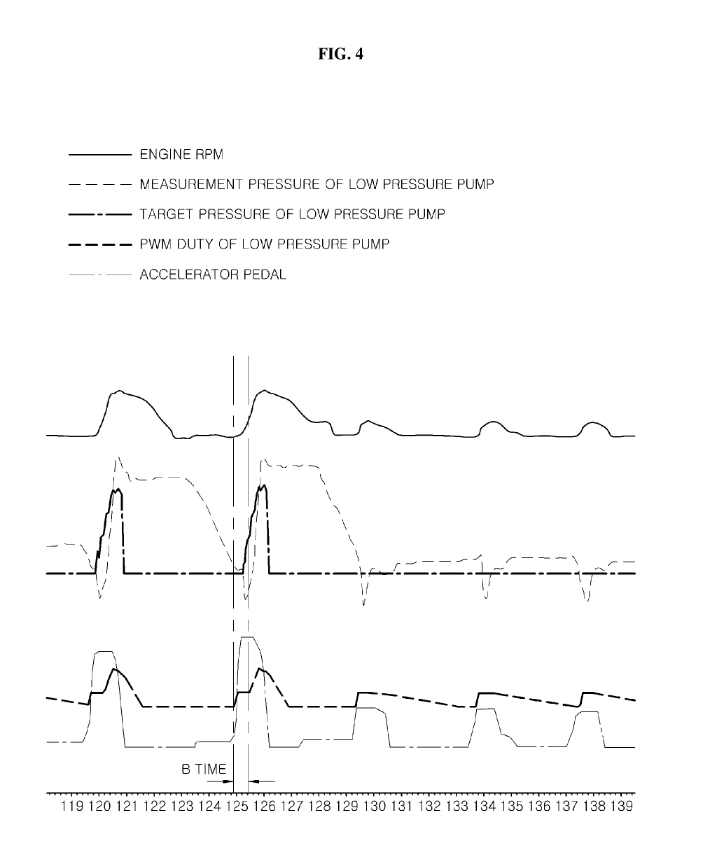

FIG. 3 is an exemplary flowchart showing a control method of a fuel pump for a vehicle according to an exemplary embodiment of the present invention, and FIG. 4 is exemplary graphs showing control results obtained from a control method of a fuel pump for a vehicle according to an exemplary embodiment of the present invention.

The control method of a fuel pump for a vehicle may include: determining, by a controller, whether an accelerator pedal signal is rapidly increased (S200); comparing, by the controller, a current control quantity of a fuel pump with a predetermined reference control quantity when the accelerator pedal signal is rapidly increased rapidly (S300); and setting, by the controller, the control quantity of the fuel pump as a predetermined jump control quantity when the current control quantity is less than the reference control quantity as a result of performing the step of comparing a current control quantity of a fuel pump with a predetermined reference control quantity (S400).

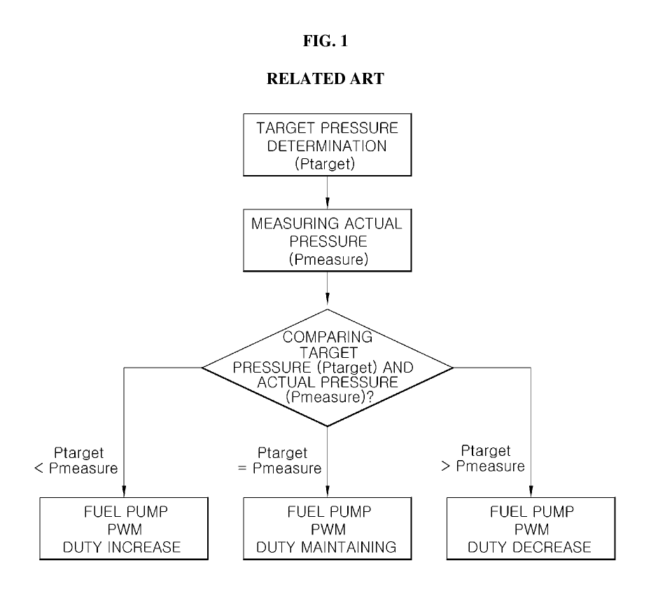

Moreover, the control quantity may be a PWM duty ratio which controls the fuel pump. In other words, according to the control method of a fuel pump for a vehicle, the controller may be configured to determine whether an accelerator pedal signal is rapidly increased while a general duty ratio is controlled at usual times, as shown FIG. 1. Further, in response to determining that the accelerator pedal signal is rapidly increased, a current control quantity of a fuel pump is compared with a predetermined reference control quantity, and when the current control quantity is less than a reference control quantity, the control quantity of a fuel pump is set as a predetermined jump control quantity.

In particular, as described above, the accelerator pedal signal may be used to determine a driver's intention of driving, wherein when it is measured that the accelerator pedal signal increases abruptly, referring to the standard as described above, a fuel pressure may be prepared to be increased for a driver's acceleration intention by forcibly increasing a duty ratio even under the condition that practical measurement pressure is increased.

Meanwhile, the jump control quantity in the control quantity replacing step may be substantially the same value as the reference control quantity in the control quantity comparing step. For example, since the jump control quantity may be less than about 50% which is a reference control quantity when the accelerator is operated abruptly, even when according to the result of comparing a practical measurement pressure at current time with the target pressure, the duty ratio should be brought as a minimum duty ratio, 10%, fuel pressure may be prepared by forcibly decreasing the jump control quantity to about 50%.

Moreover, the method may further include monitoring, by the controller, the accelerator pedal signal (S100) before the accelerator determination step. Furthermore, in the accelerator determination step, a rapid increase of the accelerator pedal signal may be determined when the accelerator pedal signal varies from a lowest limit point or less to an upper limit point or greater within a predetermined time. In other words, when the accelerator pedal signal varies from below the lowest limit point or less to the upper limit point or greater of a predetermined level within a predetermined time as an abrupt increasing of the accelerator pedal signal, the duty ratio may be increased to a predetermined jump control quantity.

FIG. 4 is exemplary graphs showing control results obtained from a control method of a fuel pump for a vehicle according to an exemplary embodiment of the present invention.

As shown at the B time in FIG. 4, when the actual measurement pressure decreases abruptly due to an excessive consumption of fuel by operating the accelerator abruptly, the duty ratio decreased due to a typical control since the actual measurement pressure decreases to below a target pressure. However, in the present invention, the accelerator pedal signal may be rapidly increased under that situation, and thus may prevent in advance an excessive drop of the actual measurement pressure by forcibly maintaining the duty ratio as a jump control quantity.

The FIG. 4 is an exemplary graph showing control results as described above wherein a substantial difference is seen between the actual measurement pressure at B time section and the target pressure is not made.

Moreover, in the control quantity replacing step, the control quantity of fuel pump may be replaced with a predetermined jump control quantity for a predetermined time (S500). In other words, an inverse effect which may happen when a predetermined duty ratio is maintained for an excessive time may be blocked, and the usual duty ratio control of FIG. 1 may be executed, as described above, after the duty ratio is forcibly maintained for the predetermined time. For reference, the fuel pump may be a substantially low pressure pump of a fuel supplying device having the low pressure pump and the high pressure pump.

According to the control method of the fuel pump for a vehicle, as described above, even when an accelerator is operated repeatedly in a vehicle provided with a fuel supplying device in which a low pressure pump variably controlled and a high pressure pump are connected in series, a fuel pressure of the low pressure pump may be increased to improve an acceleration response and drivability of a vehicle.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the accompanying claims

What is claimed is:

1. A control method of a fuel pump for a vehicle comprising:
determining, by a controller, whether an accelerator pedal signal is rapidly increased;
comparing, by the controller, a current control quantity of the fuel pump with a predetermined reference control quantity in response to determining that the accelerator pedal signal is rapidly increased; and
setting, by the controller, the control quantity of the fuel pump as a predetermined jump control quantity when the current control quantity is less than the predetermined reference control quantity.

2. The control method of a fuel pump for a vehicle of claim 1, wherein the jump control quantity is about the same value as the reference control quantity.

3. The control method of a fuel pump for a vehicle of claim 1, further comprising:
monitoring, by the controller, an accelerator pedal signal prior to determining whether the accelerator pedal signal is rapidly increased.

4. The control method of a fuel pump for a vehicle of claim 1, wherein the accelerator signal determining further comprises:
determining, by the controller, a rapid increase of the accelerator pedal signal, when the accelerator pedal signal varies from a lowest limit point or less to an upper limit or greater point within a predetermined time.

5. The control method of a fuel pump for a vehicle of claim 1, wherein the control quantity replacing further comprises:
replacing, by the controller, the control quantity of the fuel pump with a predetermined jump control quantity for a predetermined time.

6. The control method of a fuel pump for a vehicle according to claim 3, wherein the control quantity is a pulse width modulation (PWM) duty ratio which controls the fuel pump.

7. A system that controls a fuel pump for a vehicle, comprising:
a controller that includes a memory and a processor, the memory configured to store program instructions and the processor configured to execute the program instructions, the program instructions when executed configured to:
determine whether an accelerator pedal signal is rapidly increased;
compare a current control quantity of the fuel pump with a predetermined reference control quantity in response to determining that the accelerator pedal signal is rapidly increased; and
set the control quantity of the fuel pump as a predetermined jump control quantity when the current control quantity is less than the predetermined reference control quantity.

8. The system of claim 7, wherein the jump control quantity is about the same value as the reference control quantity.

9. The system of claim 7, wherein the program instructions when executed are further configured to:
monitor an accelerator pedal signal prior to determining whether the accelerator pedal signal is rapidly increased.

10. The system of claim 7, wherein the program instructions when executed are further configured to:
determine a rapid increase of the accelerator pedal signal, when the accelerator pedal signal varies from a lowest limit point or less to an upper limit or greater point within a predetermined time.

11. The system of claim 7, wherein the program instructions when executed are further configured to:
replace the control quantity of the fuel pump with a predetermined jump control quantity for a predetermined time.

12. The system of claim 9, wherein the control quantity is a pulse width modulation (PWM) duty ratio which controls the fuel pump.

13. A non-transitory computer readable medium containing program instructions executed by a controller, the computer readable medium comprising:
program instructions that determine whether an accelerator pedal signal is rapidly increased;
program instructions that compare a current control quantity of the fuel pump with a predetermined reference control quantity in response to determining that the accelerator pedal signal is rapidly increased; and
program instructions that set the control quantity of the fuel pump as a predetermined jump control quantity when the current control quantity is less than the predetermined reference control quantity.

14. The non-transitory computer readable medium of claim 13, wherein the jump control quantity is about the same value as the reference control quantity.

15. The non-transitory computer readable medium of claim 13, further comprising:
program instructions that monitor an accelerator pedal signal prior to determining whether the accelerator pedal signal is rapidly increased.

16. The non-transitory computer readable medium of claim 13, further comprising:
program instructions that determine a rapid increase of the accelerator pedal signal, when the accelerator pedal signal varies from a lowest limit point or less to an upper limit or greater point within a predetermined time.

17. The non-transitory computer readable medium of claim 13, further comprising:
program instructions that replace the control quantity of the fuel pump with a predetermined jump control quantity for a predetermined time.

18. The non-transitory computer readable medium of claim 13, wherein the control quantity is a pulse width modulation (PWM) duty ratio which controls the fuel pump.
